(19) United States
(12) Patent Application Publication
(10) Pub. No.: US 2005/0268526 A1
(43) Pub. Date: Dec. 8, 2005

(54) Flexible fish replica

(76) Inventor: Brian Delmage, Manitoba (CA)

Correspondence Address: ADE & COMPANY, 1700-360 Main St., Winnipeg Manitoba, R3C 3Z3, CA

(21) Appl. No.: 11/118,414

(22) Filed: May 2, 2005

Related U.S. Application Data
(60) Provisional application No. 60/567,799, filed on May 5, 2004.

(51) Int. Cl. A01K 85/00

(52) U.S. Cl. 43/42.3

(57) ABSTRACT

A method of preparing a flexible fish replica which comprises a body composed of flexible foam and a synthetic skin prepared from a flexible material is described.

### PRIOR APPLICATION INFORMATION

This application claims the benefit of U.S. Provisional Application 60/567,799, filed May 5, 2004.

### FIELD OF THE INVENTION

The present invention relates generally to the field of taxidermy. More specifically, the present invention relates to a flexible fish replica which has a body composed of a soft or flexible foam and a synthetic soft of flexible skin, thereby producing a fish replica which has a more realistic feel.

### BACKGROUND OF THE INVENTION

When mounting a fish, the taxidermist desires to construct a mount that imparts a lasting impression of reality. In the field of fish taxidermy, different fish forms are used for approximately every one inch length of the fish.

U.S. Pat. No. 4,755,142 teaches a form for use in fish taxidermy which through the removal of indicated portions allows the mounted fish to be posed in different positions as opposed to the prior art which requires a separate form for each position. The fish form is fabricated from a plastic material such as polyurethane, although it is stated that other easily severable lightweight materials such as Styrofoam or other pourable plastic foams could be utilized. The stated advantage of this invention is the reduction in the number of forms needed by the taxidermist.

U.S. Pat. No. 4,789,341 teaches a process for treating salmonid fish heads and skins as well as methods for treating the skins.

U.S. Pat. No. 4,408,992 teaches a method of making a taxidermy fish body insert piece. In use, the insert is prepared based on the size of the fish and the fish is skinned. A layer of putty is placed on the insert and the skin is fitted onto the insert and is then stitched together. As discussed below, there are several problems with the use of natural skin. Firstly, the skin tends to dry out over time, meaning that the natural feel is lost and the fish skin becomes hard and non-pliant. Furthermore, many countries have restrictions regarding the import of biological material, which includes mounted fish with natural skin.

Thus, one of the problems with the prior art methods is that the replica fish produced are rigid and hard to the touch, meaning that the “impression of reality” is often ruined upon touching the specimen. Clearly an improved replica fish that is pliant to the touch and therefore feels more “real” is needed.

### SUMMARY OF THE INVENTION

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a flexible fish replica comprising a body comprising a soft or flexible foam and a soft or flexible synthetic skin, and a method for making same. As will be appreciated by one of skill in the art, this is in contrast with fish replica known in the art which are typically composed of fibreglass or polyester and are therefore rigid and are not soft to the touch or flexible.

Specifically, flexible foams are primarily used in cushioning applications whereas rigid foams are used as thermal insulation. In flexible foams, the cells are made up of two structural parts: cell walls (called struts) and open window areas (called voids). The strut and void structure allows air to pass through the foam when force is applied. The elasticity of the strut acts as a shock absorber and allows the foam to recover shape after compression. While rigid foam cells have much the same structure, the windows in the cell walls are closed, restricting air flow but improving thermal efficiency. In a preferred embodiment, the flexible foam is a polyurethane foam although other suitable flexible foams known in the art may also be used.

The method of preparing the flexible fish replica is as follows.

As will be appreciated by one of skill in the art, a taxidermist may have several molds for a given variety or species of fish, typically one mold for each one inch length of a fish. These molds may be made from any suitable material known in the art, for example, but by no means limited to, plaster, rubber, fibreglass or silicone. Typically, the mold is prepared initially using a frozen or unfrozen specimen of the species or variety of fish.

The mold is prepared for use by applying release wax to the mold. As will be appreciated by one of skill in the art, the mold is composed of two or more parts. Wax, release agents, paints, pigments and the like are applied in succession as discussed below as layers to the surface of the mold portions. The mold is then assembled prior to pouring of the flexible foam, as discussed below.

A wax is buffed onto the mold and in some embodiments a second coat of release wax is applied. Next, a release agent is applied to the mold and allowed to dry. As will be appreciated by one of skill in the art, the releasing agent that is selected must be compatible with the other materials selected, as discussed below.

At this stage, a suitable paint may be air-brushed into the mold. In most embodiments, black paint is used, although other suitable colors may be used, provided that the paint used is compatible with the other components described herein. The air-brushed paint is then wiped down, which provides detailing on the skin for the finished product. As discussed below, in other embodiments, the paint is applied after the body is cast.

Next, a flexible skin is prepared for application to the fish replica. As discussed below, the flexible skin is a synthetic skin prepared from a flexible, paintable material. In some embodiments, the flexible, paint-able material is a flexible epoxy which is brushed onto the mold and allowed to dry. This epoxy forms part of the skin of the finished product. In yet further embodiments, a second layer of the flexible epoxy is applied onto the first layer, thereby providing additional thickness for the skin. As will be appreciated by one of skill in the art, the thickness of the skin will vary in accordance with the amount of flexible, paint-able material but is typically on the order of 0.25 mm to 2 mm. It is noted that flexible epoxies are well-known in the art and that once applied cure to a firm yet rubbery coating that will flex and stretch. Flexible epoxies are typically used for projects that require soft textures and as used herein will produce a skin that is flexible to the touch. Alternatively, the skin may be made from other suitable flexible, paint-able material, for example but by no means limited to polyurethanes, plastics, rubbers, latex or other epoxies. It is of note that suitable flexible materials can be easily identified by consulting any of a number of resource materials known to those of skill in the art. In some embodiments, the skin is made in a first mold, prepared initially as discussed above, and then applied to the flexible foam body once the body has been cast or cured. In other embodiments, the flexible skin and the flexible foam body are cast in the same mold, as described above. In yet other embodiments, the flexible skin is cast as described above on a frozen or unfrozen specimen of the desired species, allowed to cure and then mounted within the mold, that is, mounted onto the inner surfaces of the mold components. The embodiments in which the flexible skin and the flexible foam body are cast in the same mold are further described herein for illustrative purposes, although as will be appreciated by one of skill in the art, a similar overall process is followed when the skin is prepared after casting except that the steps are done in a different order.

Next, base color is applied on top of the epoxy in the mold. As will be appreciated by one of skill in the art, the exact color will vary in accordance with the type of fish of which the replica is being prepared.

Next, a white paint is applied, for example, a water-based white latex paint.

It is of note that at this stage of the process, fins and/or the head and/or the tail may be applied to the mold, that is, prior to the addition of the foam. In some embodiments, the fins are flexible fins. In alternative embodiments, the fins and/or head and/or tail may be applied once the foam body has been cast. It is further noted that synthetic fins and tails are well-known in the taxidermy arts and any suitable synthetic fin or tail may be used with the fish replica described herein. Furthermore, methods for casting artificial heads are also well-known and any of a variety thereof may be used with the invention.

In other embodiments, the mold may be arranged such that a tail is cast as part of the body on addition of the foam, as discussed below.

The molds are then assembled and sealed together, for example, by placing a bead of epoxy or other adhesive along the rims of the molds or by taping the molds together or by other means known in the art. The molds are then clamped together in preparation for the addition of the foam, as discussed below.

It is of note that in some embodiments, a block or mounting unit is inserted into one of the molds or positioned between the molds prior to assembly. Alternatively, a portion of the body may be removed after casting and the block may be inserted into said opening. As will be apparent to one of skill in the art, the block or mounting unit is used for mounting the flexible fish replica for further preparation (such as additional painting, detailing etc) and/or display (when finished).

The assembled mold forms a receptacle for the foam and the flexible foam is poured into the assembled mold. The foam is then allowed to cure, thereby producing a flexible foam fish replica body.

As will be appreciated by one of skill in the art and as discussed above, any suitable flexible foam known in the art and being compatible with the other components listed above may be used. The density of the flexible foam is for example between 3 lb per cubic foot to 15 lb per cubic foot. In a preferred embodiment, the flexible foam has a density between 5 lb to 15 lb per cubic foot. In other embodiments, the flexible foam has a density between 7 lb per cubic foot to 15 lb per cubic foot. In yet other embodiments, the flexible foam has a density between 10 lb per cubic foot to 15 lb per cubic foot. As will be appreciated by one of skill in the art, the higher the density, the “firmer” the fish replica body produced from the foam. Thus, a body prepared from 5 lb per cubic foot foam will be more flexible and more pliant to the touch than a body prepared from 15 lb per cubic foot foam.

As discussed above, at this stage, synthetic fins, tail and head may be applied if not done so previously. Similarly, painting of the body may also be done if necessary. In addition, as discussed above, a portion of the body may be removed for inserting a mounting unit or block therein for mounting the flexible fish replica body for display.

As will be appreciated by one of skill in the art, the flexible foam fish replica is thus assembled “outside-in”, wherein the outer layers are applied to the inner surfaces of the molds in succession and the molds are then assembled to form a master mold into which the flexible foam is poured.

It is of note that backboards or support systems can be added during or after the manufacture of the fish replica, depending upon the background used for mounting. For example, wire or metal can be added to the mold prior to addition of the foam to give support of to change the position of the fish replica slightly to modify the appearance of the fish replica.

As will be appreciated by one of skill in the art, paints and pigments can be added at any stage during the above-described process, depending on the desired effect. That is, specific patterns, tones and characteristics may be best applied during the replica process while others may be better applied once the flexible body has been cast and allowed to cure. It is further of note that a wide variety of paints may be used on the condition that the selected paints are compatible with for example the flexible and paint-able material used for the flexible synthetic skin as discussed above.

The finishing of the replica fish is completed by adding heads, eyes, gills and fins if not already done, as discussed above.

The end product is a flexible fish replica that is more pliant to the touch and has a more realistic appearance.

It is of note that the flexible body is composed of a flexible foam and is a replica of a fish body. That is, the body is composed of flexible foam and includes a flexible skin composed of a flexible and paint-able material, not of a fish body with an insert inserted therein to support the body or skin of an actual fish. As used herein, the “body” in regard the flexible body refers to the body portion of the fish replica or the body and tail portion of the fish replica.

As discussed above, the instant invention represents an improvement over the prior art. Specifically, as discussed above, the combination of the flexible foam body and the flexible skin produces a fish replica that is resilient to the touch. That is, the flexible fish replica feels like a real fish and is not hard to the touch as is the case with fish replicas prepared with fibreglass or polyesters. A further advantage compared to fish replicas prepared with fibreglass or polyesters is that a body prepared in this manner must be ground or flashed to produce a smooth finished product which is labor-intensive and time-consuming. This is in contrast with the flexible fish replica described herein which can easily be trimmed or shaved. Similarly, in embodiments wherein the tail is cast as part of the body, the tail of the flexible fish replica is also flexible and can easily be cut or otherwise detailed to more realistically simulate a real tail portion.

Furthermore, as discussed above, the flexible fish replica as described herein is a reproduction of a fish and does not contain any parts of the fish. As discussed above, the combination of the flexible foam body and the flexible skin produces a replica that “gives” when touched, thereby providing a more realistic feel compared to prior art replicas. Furthermore, as discussed above, the synthetic skin does not dry out as is the case with natural skins and has the added advantage of being a reproduction, meaning that there is no biological material used, thereby easing shipping and transport of the replica.

While the preferred embodiments of the invention have been described above, it will be recognized and understood that various modifications may be made therein, and the appended claims are intended to cover all such modifications which may fall within the spirit and scope of the invention.

1. A fish replica comprising: a flexible foam body and a flexible skin.

2. The fish replica according to claim 1 wherein the flexible foam is at a density of between about 3 lb per cubic foot to about 15 lb per cubic foot.

3. The fish replica according to claim 1 wherein the flexible foam is at a density of between about 5 lb per cubic foot to about 15 lb per cubic foot.

4. The fish replica according to claim 1 wherein the flexible foam is at a density of between about 7 lb per cubic foot to about 15 lb per cubic foot.

5. The fish replica according to claim 1 wherein the flexible foam is at a density of between about 10 lb per cubic foot to about 15 lb per cubic foot.

6. The fish replica according to claim 1 wherein the flexible skin is composed of a flexible epoxy.

7. A method of preparing a flexible fish replica comprising:
a) providing a fish body mold;
b) applying a release agent to the mold;
c) applying at least one layer of a flexible material to the mold and allowing said flexible material to cure;
d) pouring a flexible foam into the mold; and
e) allowing the foam to cure, thereby forming a flexible fish replica.

8. The method according to claim 7 wherein the flexible foam is at a density of between about 3 lb per cubic foot to about 15 lb per cubic foot.

9. The method according to claim 7 wherein the flexible foam is at a density of between about 5 lb per cubic foot to about 15 lb per cubic foot.

10. The method according to claim 7 wherein the flexible foam is at a density of between about 7 lb per cubic foot to about 15 lb per cubic foot.

11. The method according to claim 7 wherein the flexible foam is at a density of between about 10 lb per cubic foot to about 15 lb per cubic foot.

12. The method according to claim 7 wherein the flexible material is composed of a flexible epoxy.
